(19) United States
(12) Patent Application Publication
(10) Pub. No.: US 2024/0224057 A1
(43) Pub. Date: Jul. 4, 2024

(54) SIMULTANEOUS SHARING OF SPECTRAL BANDWIDTH BETWEEN MULTIPLE BSSS USING BANDWIDTH PUNCURING

(71) Applicant: Fortinet, Inc., Sunnyvale, CA (US)

(72) Inventor: Vijayakumar Vellaichamy, Jogupalaya (IN)

(73) Assignee: Fortinet, Inc., Sunnyvale, CA (US)

(21) Appl. No.: 18/375,049

(22) Filed: Sep. 29, 2023

Related U.S. Application Data
(63) Continuation-in-part of application No. 18/203,272, filed on May 30, 2023.
Application No. 18/203,272 is a continuation-in-part of application No. 18/092,297, filed on Dec. 31, 2022.

(51) Int. Cl. H04W 16/14; H04L 1/00; H04W 74/08; H04W 74/0816

(52) U.S. Cl. CPC H04W 16/14; H04L 1/0069; H04W 74/0816; H04W 74/0866

(57) ABSTRACT

BSS (basic service set) sharing is enabled on the Wi-Fi 7 access point, wherein the Wi-Fi 7 access point is wirelessly connected to a plurality of stations over the common wireless channel. A puncturing pattern is determined to share spectrum of the common wireless channel between the multiple BSSs. All shared BSSs are advertised in beacons with an EHT field comprising the puncturing pattern and broadcast over the common wireless channel. At least two stations of the plurality of stations are connected over at least two different BSSs of the multiple BSSs. Data frames are transmitted simultaneously to the at least two stations across the at least two different BSSs. A first BSS occupies a first portion of a spectrum and a second BSS occupies a second portion of the spectrum, according to the puncturing pattern.

### CROSS-REFERENCE TO RELATED APPLICATIONS

The present invention claims priority as a continuation-in-part under 35 USC 120 (a) to U.S. application Ser. No. 18/203,272, filed May 30, 2023, by Vijayakumar V, which is a continuation-in-part under 35 USC 120 (a) to U.S. application Ser. No. 18/092,297, filed Dec. 31, 2022, by Vijayakumar V, the contents of each are incorporated herein in their entirety.

### FIELD OF THE INVENTION

The invention relates generally to computer networks, and more specifically, for simultaneous sharing of spectral bandwidth between the multiple BSSs of a Wi-Fi 7 access point using bandwidth puncturing.

### BACKGROUND

Access points generally connect wireless stations to a wired backbone network. BSSs (basic service sets) provide certain services for connecting stations and different BSSs can be used to differentiate between services offered to stations. In an access point configured with 160 Mhz channel-width settings, two SSIDs can be configured to use two different BSS. However, access points use an entire 160 Mhz channel-width for a single BSS even though clients are connected with 80 Mhz. Consequently, a second BSS has to wait for its turn to transmit over a different transmission opportunity (TxOP).

What is needed is a robust technique for simultaneous sharing of spectral bandwidth between the multiple BSSs using bandwidth puncturing.

### SUMMARY

To meet the above-described needs, methods, computer program products, and systems for simultaneous sharing of spectral bandwidth between the multiple BSSs using bandwidth puncturing.

In one embodiment, BSS sharing is enabled on the Wi-Fi 7 access point, wherein the Wi-Fi 7 access point is wirelessly connected to a plurality of stations over the common wireless channel. A puncturing pattern is determined to share spectrum of the common wireless channel between the multiple BSSs. All shared BSSs are advertised in beacons with an EHT field comprising the puncturing pattern and broadcast over the common wireless channel.

In another embodiment, at least two stations of the plurality of stations are connected over at least two different BSSs of the multiple BSSs. Data frames are transmitted simultaneously to the at least two stations across the at least two different BSSs. A first BSS occupies a first portion of a spectrum and a second BSS occupies a second portion of the spectrum, according to the puncturing pattern.

Advantageously, network performance is improved with increased throughput with more efficient spectral usage.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1A is a high-level block diagram illustrating a system for simultaneous sharing of spectral bandwidth between the multiple BSSs using bandwidth puncturing, according to some embodiments.

FIG. 1B is a block diagram illustrating an example puncturing pattern implemented in EHT fields of beacons.

FIG. 2 is a more detailed block diagram illustrating a Wi-Fi 7 controller of the system of FIG. 1A, according to one embodiment.

FIG. 3 is a more detailed block diagram illustrating a Wi-Fi 7 access point of the system of FIG. 1A, according to one embodiment.

FIG. 4 is a high-level flow diagram illustrating a method for connecting multiple stations, according to an embodiment.

FIG. 5 is a more detailed flow diagram illustrating a step for simultaneous sharing of spectral bandwidth between the multiple BSSs using bandwidth puncturing, from the method of FIG. 4, according to one embodiment.

FIG. 6 is a block diagram illustrating an example computing device for the system of FIG. 1, according to one embodiment.

### DETAILED DESCRIPTION

Methods, computer program products, and systems for simultaneous sharing of spectral bandwidth between the multiple BSSs using bandwidth puncturing. The following description has been limited for the purpose of conciseness, although one of ordinary skill in the art will recognize many different variations within the spirit of the disclosed embodiments.

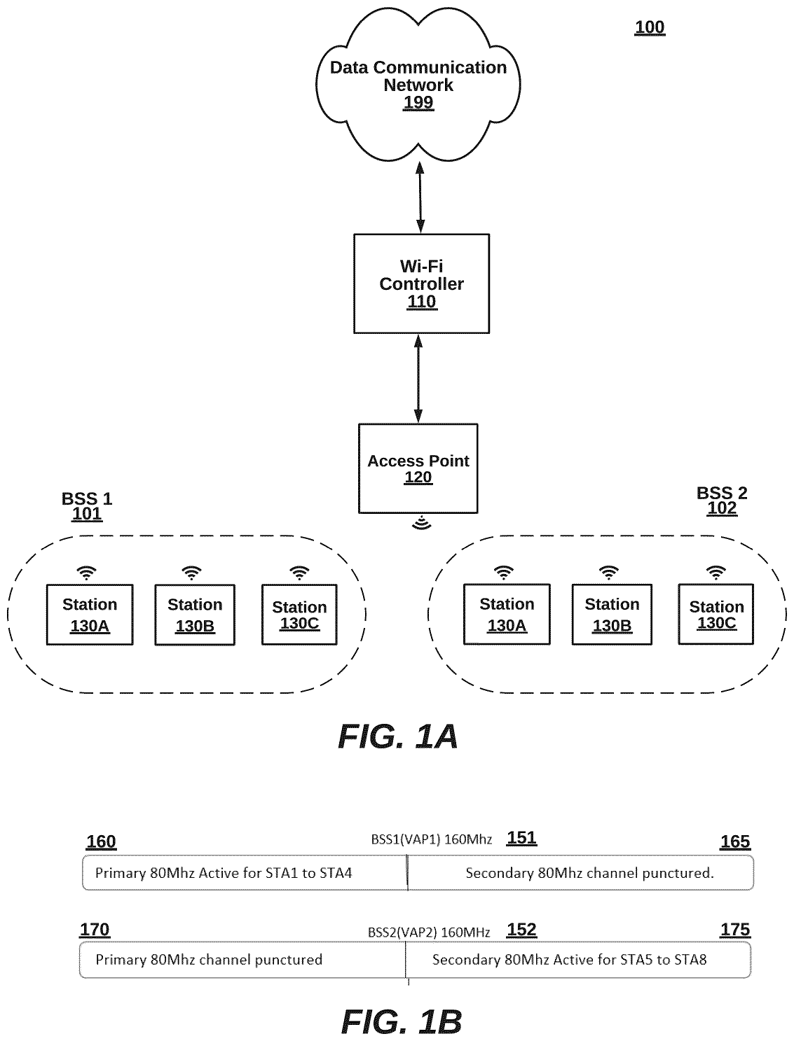

### I. Systems for Multiple BSS Sharing Spectrum (FIGS. 1-3)

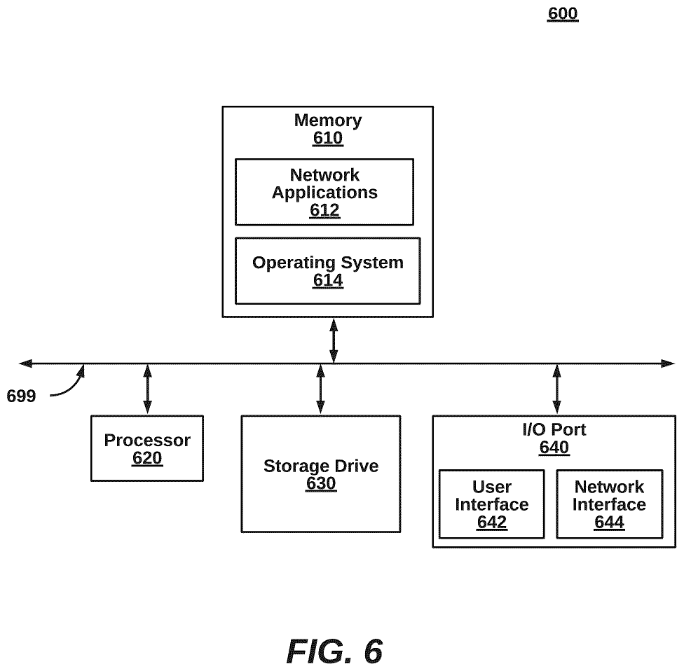

FIG. 1A is a high-level block diagram illustrating a system 100 for simultaneous sharing of spectral bandwidth between the multiple BSSs using bandwidth puncturing, according to an embodiment. The system 100 includes a Wi-Fi controller 110, Wi-Fi 7 access point 120 and stations 130A-F. Other embodiments of the system 100 can include additional components that are not shown in FIG. 1, such as controllers, network gateways, firewalls, access points and stations. The components of system 100 can be implemented in hardware, software, or a combination of both. An example implementation is shown in FIG. 6.

In one embodiment, the components of the system 100 are coupled in communication over a private network connected to a public network, such as the Internet. In another embodiment, system 100 is an isolated, private network. The components can be connected to the data communication system via hard wire (e.g., Wi-Fi controller 110 and Wi-Fi 7 access points 120A-C). The access points can also be connected via wireless networking (e.g., stations 130A-F). The data communication network can be composed of any data communication network such as an SDWAN, an SDN (Software Defined Network), WAN, a LAN, WLAN, a cellular network (e.g., 3G, 4G, 5G or 6G), or a hybrid of different types of networks. Various data protocols can dictate format for the data packets. For example, Wi-Fi data packets can be formatted according to IEEE 802.11, IEEE 802.11r, 802.11be, Wi-Fi 6, Wi-Fi 6E, Wi-Fi 7 and the like. Components can use Ipv4 or Ipv6 address spaces.

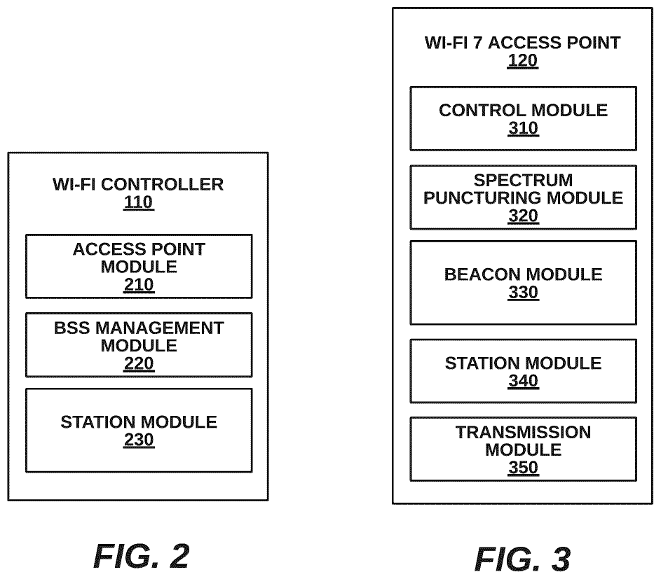

The Wi-Fi controller 110 manages sharing of access point spectrum between multiple BSSs. When the Wi-Fi 7 access point 120 and other access points come online, the Wi-Fi controller 110 coordinates operations having a network-wide view of devices. For BSSs shared amongst a single access point, RUS (resource units) are assigned to split the spectrum. When a first BSS wins the TXOP (transmission opportunity) and shares information with the Wi-Fi controller 110, the information is forwarded to a second BSS of the same access point to use the same TXOP. The TXOP, generally, is a MAC layer feature used in IEEE 802.11-based WLAN and applies for traffic flowing from stations to access points and vice-versa, measure in milliseconds. Table 1 shows one example of a 160 MHz spectrum split between to BSSs of 80 MHz channel widths, one primary and one secondary. Furthermore, each 80 MHz split can accommodate four 20 MHz channel widths. As a result, the Wi-Fi 7 access point 120 transmits downlink packets to stations simultaneously. Below, the Wi-Fi controller 110 is discussed in more detail with respect to FIG. 2.

TABLE 1

| | Bandwidth in AP | | | | | | | |
|---|---|---|---|---|---|---|---|---|
| | 36/160 Mhz | | | | | | | |
| BSS | BSS1 uses Primary 80 MHz for data | | | | BSS2 uses secondary 80 Mhz data | | | |
| Channel | 36 | 40 | 44 | 48 | 52 | 56 | 60 | 64 |
| Channel width | 20 | 20 | 20 | 20 | 20 | 20 | 20 | 20 |

The Wi-Fi access points 120 implement spectrum sharing between BSSs under direction of the Wi-Fi controller 110. Initially, a network administrator or automated process enables BSS sharing. Generally, access points advertise connection abilities to stations using beacons, and respond to stations requesting a connection. A virtual access point features facilities multiple BSSs at a common access point. A first type of beacon beacons include a first BSS 151 as a primary sub channel 160 and a second BSS as a punctured secondary sub channel 165. A second type of beacon is opposite, including the second BSS 152 as a primary sub channel 170 and the first BSS as a punctured secondary sub channel 175. More detailed embodiments of Wi-Fi access points 120A-C are set forth below in association with FIG. 3.

The stations 130A-F connects to nearby access points over wireless channels for uploading and downloading data from the data communication network. Some data is exchanged local to a LAN and other data is exchanged outside the LAN over the Internet. To initiate a connection, the station 130 can select an access point and send a probe request using a BSS corresponding to the desired connection. Then one of the stations 130A-F receives a probe response from the Wi-Fi 7 access points 120 The probe response includes an RNR containing connection information for nearby access points that has been gathered. In turn, the station 130 selects an access point through a corresponding BSSID to use for connecting to the backbone network. Once connected, data can be transmitted to destinations and received from sources on networks, using a spectrum shared among BSSs.

FIG. 2 is a more detailed block diagram illustrating the Wi-Fi controller 110 of the system of FIG. 1A, according to one embodiment. The Wi-Fi controller 110 includes an access point module 210 to connect with the Wi-Fi 7 access point 120 and others. Statistics can be collected from individual access points and used in network-wide decisions. The BSS management module 220 enables sharing of BSSs over the spectrum of the Wi-Fi 7 access point 120 by assigning RU units to different BSSs. The station module 230 tracks individual stations from a network-side perspective. The components can be implemented in hardware, software, or a combination of both.

FIG. 3 is a more detailed block diagram illustrating the Wi-Fi 7 access point 120 of the system of FIG. 1, according to one embodiment. The Wi-Fi 7 access point 120 includes a control module 310, a spectrum puncturing module 320, a beacon module 330, a station module 340 and a transmission module 350. The components can be implemented in hardware, software, or a combination of both.

The control module 310 can enable BSS sharing on the Wi-Fi 7 access point 120. The Wi-Fi 7 access point 120 is wirelessly connected to a plurality of stations over the common wireless channel.

The spectrum puncturing module 320 determines a puncturing pattern to share spectrum of the common wireless channel between the multiple BSSs. Generally, puncturing channel is used by a transmitting device that omits portions of a channel bandwidth based on a puncturing pattern. The puncturing pattern is to avoid transmissions on portions of channels. The selection of punctured sub channels is indicated in beacon including the Disabled Subchannel Bitmap in EHT Operation Information subfield of EHT Operation Element.

The beacon module 330 to advertise at least two BSSs in beacons with an EHT field comprising the puncturing pattern and broadcast over the common wireless channel.

The station module 340 connect at the least two stations of the plurality of stations over at least two different BSSs of the multiple BSSIDs of the multiple BSSs,

The transmission module 350 transmits data frames simultaneously to the at least two stations across the at least two different BSSs. A first BSS occupies a first portion of a spectrum and a second BSS occupies a second portion of the spectrum. Data is packetized according to Wi-Fi 7 or other protocols. The transmission module 350 can also include transceivers, antennae, and other components used during transmission and reception over a wireless channel.

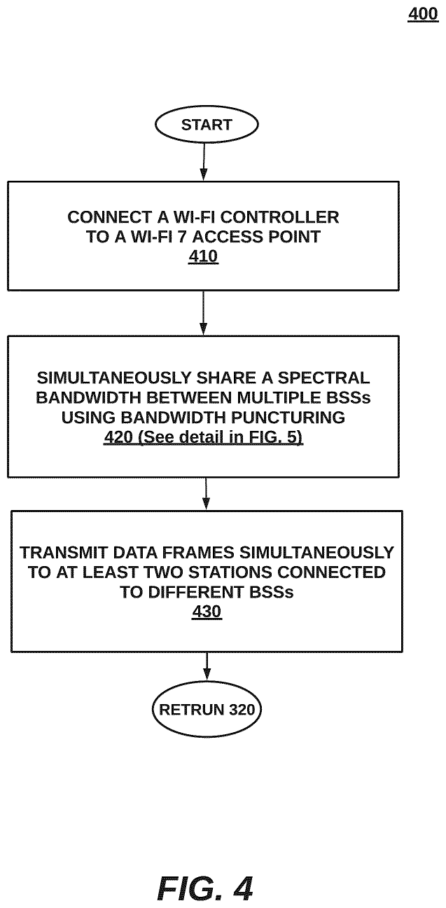

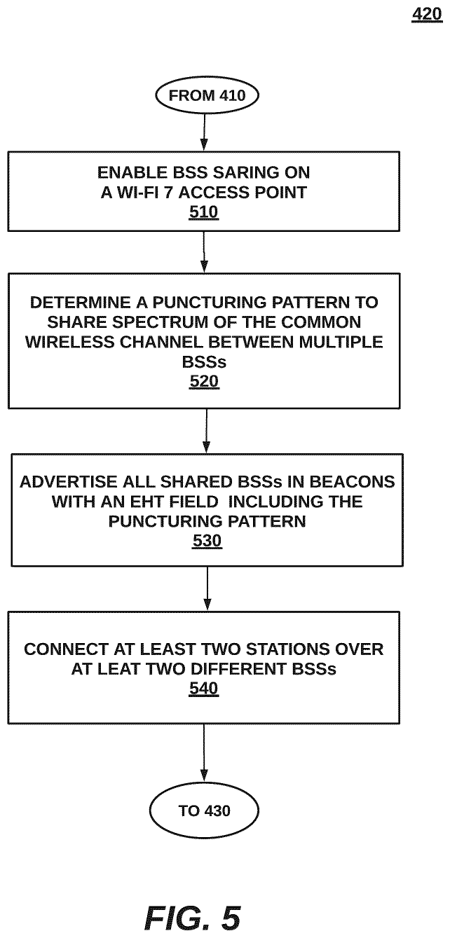

### II. Methods for Multiple BSS Sharing Spectrum (FIGS. 4-5)

FIG. 4 is a high-level flow diagram of a method 300 for connecting multiple stations, according to an embodiment. The method 400 can be implemented by, for example, system 100 of FIG. 1. The specific grouping of functionalities and order of steps are a mere example as many other variations of method 300 are possible, within the spirit of the present disclosure.

At step 410, a Wi-Fi controller connects to a Wi-Fi 7 access point on a data communication network. At step 420, simultaneous sharing of spectral bandwidth between the multiple BSSs using bandwidth puncturing, as discussed in more detail below. At step 430, transmitting data frames simultaneously to the at least two stations across the at least two different BSSs, wherein a first BSS occupies a first portion of a spectrum and a second BSS occupies a second portion of the spectrum.

FIG. 5 is a more detailed flow diagram detailing the step 420 of simultaneous sharing of spectral bandwidth between the multiple BSSs using bandwidth puncturing, according to an embodiment. Other variations are possible.

At step 510, BSS sharing is enabled on a Wi-Fi 7 access point. The Wi-Fi 7 access points is wirelessly connected to a plurality of stations over the common wireless channel.

At step 520, a puncturing pattern is determined to share spectrum of the common wireless channel between the multiple BSSs.

At step 530, all shared BSSs are advertised in beacons with an EHT field comprising the puncturing pattern and broadcast over the common wireless channel.

At step 540, at least two stations of the plurality of stations are connected over at least two different BSSs of the multiple BSSIDs of the multiple BSSs.

### III. Computing Device for Multiple BSS Sharing Spectrum (FIG. 6)

FIG. 6 is a block diagram illustrating a computing device 600 for use in the system 100 of FIG. 1, according to one embodiment. The computing device 600 is a non-limiting example device for implementing each of the components of the system 100, including the Wi-Fi controller 110, the Wi-Fi 7 access point 120 and the stations 130A-F. Additionally, the computing device 600 is merely an example implementation itself, since the system 100 can also be fully or partially implemented with laptop computers, tablet computers, smart cell phones, Internet access applications, and the like.

The computing device 600, of the present embodiment, includes a memory 610, a processor 620, a hard drive 630, and an I/O port 640. Each of the components is coupled for electronic communication via a bus 650. Communication can be digital and/or analog, and use any suitable protocol.

The memory 610 further comprises network access applications 612 and an operating system 614. Network access applications can include 612 a web browser, a mobile access application, an access application that uses networking, a remote access application executing locally, a network protocol access application, a network management access application, a network routing access applications, or the like.

The operating system 614 can be one of the Microsoft Windows® family of operating systems (e.g., Windows 98, 98, Me, Windows NT, Windows 2000, Windows XP, Windows XP x84 Edition, Windows Vista, Windows CE, Windows Mobile, Windows 7 or Windows 8), Linux, HP-UX, UNIX, Sun OS, Solaris, Mac OS X, Alpha OS, AIX, IRIX32, or IRIX84. Other operating systems may be used. Microsoft Windows is a trademark of Microsoft Corporation.

The processor 620 can be a network processor (e.g., optimized for IEEE 802.11), a general purpose processor, an access application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 620 can be single core, multiple core, or include more than one processing elements. The processor 620 can be disposed on silicon or any other suitable material. The processor 620 can receive and execute instructions and data stored in the memory 610 or the hard drive 630.

The storage device 630 can be any non-volatile type of storage such as a magnetic disc, EEPROM, Flash, or the like. The storage device 630 stores code and data for access applications.

The I/O port 640 further comprises a user interface 642 and a network interface 644. The user interface 642 can output to a display device and receive input from, for example, a keyboard. The network interface 644 connects to a medium such as Ethernet or Wi-Fi for data input and output. In one embodiment, the network interface 644 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C #, Oracle® Java, Javascript, PHP, Python, Perl, Ruby, AJAX, and Adobe® Flash®. The computer software product may be an independent access point with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

The phrase “network appliance” generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, layer ⅔ routing, content inspection, content filtering, firewall, traffic shaping, application control, Voice over Internet Protocol (VOIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTI Wi-Fi family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical access applications. This description will enable others skilled in the art to best utilize and practice the invention in various embodiments and with various modifications as are suited to a particular use. The scope of the invention is defined by the following claims.

I claim:

1. A computer-implemented method in a Wi-Fi 7 access point on a data communication network and having multiple BSSs on a common wireless channel, for simultaneous sharing of spectral bandwidth between the multiple BSSs using bandwidth puncturing, the method comprising:
enabling BSS sharing on the Wi-Fi 7 access point, wherein the Wi-Fi 7 access points is wirelessly connected to a plurality of stations over the common wireless channel;
determining a puncturing pattern to share spectrum of the common wireless channel between the multiple BSSs;
advertising all shared BSSIDs in beacons with an EHT field comprising the puncturing pattern and broadcast over the common wireless channel;
connecting at least two stations of the plurality of stations over at least two different BSSs of the multiple BSSs of the multiple BSSs; and
transmitting data frames simultaneously to the at least two stations across the at least two different BSSs, wherein a first BSS occupies a first portion of a spectrum and a second BSS occupies a second portion of the spectrum, according to the puncturing pattern.

2. The method of claim 1, wherein the puncturing pattern shares a spectrum of 160 MHZ, allocating 80 MHz to a first BSSID and 80 MHz to a second BSSID, of the multiple BSSIDs.

3. The method of claim 1, wherein the beacons include first beacons with a first BSS beacon advertising a second BSS subchannel in the EHT element, and the beacons include second beacons with a second BSS advertising a first BSS subchannel in the EHT element.

4. The method of claim 1 wherein a first BSS wins TXOP (transmission opportunity) privileges and shares related information to a Wi-Fi controller, and the Wi-Fi controller shares the related information to a second BSSI for use for the same TXOP privileges.

5. The method of claim 1, wherein a Wi-Fi controller assigns the at least two stations to the at least two different BSSs.

6. A non-transitory computer-readable medium in a Wi-Fi 7 access point on a data communication network and having multiple BSSs on a common wireless channel, for simultaneous sharing of spectral bandwidth between the multiple BSSs using bandwidth puncturing, the method comprising:
enabling BSS sharing on the Wi-Fi 7 access point, wherein the Wi-Fi 7 access points is wirelessly connected to a plurality of stations over the common wireless channel;
determining a puncturing pattern to share spectrum of the common wireless channel between the multiple BSSs;
advertising all shared BSSIDs in beacons with an EHT field comprising the puncturing pattern and broadcast over the common wireless channel;
connecting at least two stations of the plurality of stations over at least two different BSSs of the multiple BSSs of the multiple BSSs; and
transmitting data frames simultaneously to the at least two stations across the at least two different BSSs, wherein a first BSS occupies a first portion of a spectrum and a second BSS occupies a second portion of the spectrum, according to the puncturing pattern.

7. A Wi-Fi 7 access point on a data communication network and having multiple BSSs on a common wireless channel, for simultaneous sharing of spectral bandwidth between the multiple BSSs using bandwidth puncturing, the Wi-Fi controller comprising:
a processor;
a network interface communicatively coupled to the processor and to a data communication network; and
a memory, communicatively coupled to the processor and storing:
a control module to enable BSS sharing on the Wi-Fi 7 access point, wherein the Wi-Fi 7 access points is wirelessly connected to a plurality of stations over the common wireless channel;
a spectrum puncturing module to determine a puncturing pattern to share spectrum of the common wireless channel between the multiple BSSs;
a beacon module to advertise at least two BSSs in beacons with an EHT field comprising the puncturing pattern and broadcast over the common wireless channel; and
a station module to connect at the least two stations of the plurality of stations over at least two different BSSs of the multiple BSSIDs of the multiple BSSs,
wherein the network interface transmits data frames simultaneously to the at least two stations across the at least two different BSSs, wherein a first BSS occupies a first portion of a spectrum and a second BSS occupies a second portion of the spectrum, according to the puncturing pattern.
